(19) United States
(12) Patent Application Publication
(10) Pub. No.: US 2006/0268372 A1
(43) Pub. Date: Nov. 30, 2006

(54) Document positioning apparatus for document camera

(75) Inventors: Chung-Song Kuo, Chung Ho City (TW); Ming-Te Cheng, Chung Ho City (TW); Shi-Mu Sun, Chung Ho City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AverMedia Technologies, Inc.

(21) Appl. No.: 11/178,963

(22) Filed: Jul. 11, 2005

(30) Foreign Application Priority Data
May 27, 2005 (TW) 94117583

(51) Int. Cl. H04N 1/04

(52) U.S. Cl. 358/488

(57) ABSTRACT

A document positioning apparatus has a supporter. The supporter is disposed under a base of a document camera. A gap is formed between the supporter and a ground surface used to support the supporter and the gap is designed to be large enough for a document to shift. The document positioning apparatus further has a document guider, formed on an edge of the supporter to guide the document into the gap under the supporter easily.

### RELATED APPLICATIONS

The present application is based on, and claims priority from, Taiwan Application Serial Number 94117583, filed May 27, 2005, the disclosure of which is hereby incorporated by reference herein in its entirety.

### BACKGROUND

1. Field of Invention

The present invention relates to a document positioning apparatus. More particularly, the present invention relates to a document positioning apparatus for a document camera.

2. Description of Related Art

Traditionally, a common presentation apparatus is a projector for projecting images. With the advancement of technology, the useful presentation apparatus at present includes a projector with an LCD, a laptop and a document camera.

The document camera may directly present an object on a monitor without previously transforming the object, such as a document or material, into an image file or a document file. The document camera uses a digital camera to capture an image of the object and directly presents the image on a monitor. Therefore, by using the document camera, a presenter will save a lot of time by not preparing the presentation data previously.

When the document camera is used to capture a document for presentation, in general, it is necessary for a presenter to move the image camera to a suitable capture position because of the physical limitation of a base of the document camera. Once the position of the image camera is moved, the focus of the image camera must be adjusted again. Therefore, it is time-consuming and inconvenient for a presenter to adjust the focus of the image camera.

FIG. 1 is a schematic diagram of a conventional document camera in the process of capturing a document for presentation. An image camera 106 of a document camera 100 is connected to a base 102 through an arm 104. Because of a physical limitation of the base 102, the image camera 106 can only capture a surrounding image centered at point A when the image camera 106 is moved to the position P₁ In this case, a clear image in A is obtained while an unclear image at a distance from A is obtained. When the image camera 106 captures a surrounding image centered at B, the presenter must move the image camera 106 to a position P₂ and readjust a focus of the image camera 106. Therefore, it is inconvenient to capture a document for presentation by using a conventional document camera.

### SUMMARY

It is therefore an objective of the present invention to provide a document positioning apparatus for a document camera, which is able to resolve the problem time wasted in adjusting a position and a focus of an image camera.

According to the foregoing objectives of the invention, the present invention provides a document positioning apparatus comprising a supporter, a roller device and a document guider. The supporter is disposed under a base of a document camera. A gap is formed between the supporter and a ground surface used to support the supporter and the gap is made large enough for a document to shift. The roller device is installed on a bottom surface of the supporter for moving the document to achieve a desired position. A document guider is formed on an edge of the supporter for guiding the document into the gap under the supporter easily. The roller device is connected to and driven by a motor.

According to the foregoing objectives of the invention, the present invention provides a document positioning apparatus comprising a supporter. The supporter is disposed under a base of a document camera. A gap is formed between the supporter and a ground surface used to support the supporter. The gap is made large enough for a document to shift. The document positioning apparatus further comprises a document guider. The document guider is formed on an edge of the supporter for guiding the document into the gap under the supporter easily. A base of a light set can be combined with the document positioning apparatus, so that the document can be shifted into the gap of the document positioning apparatus under the base of the light set and the base of the document camera.

As described above, by using the document positioning apparatus combined with the document camera of the present invention, a document can be moved to a position under the image camera, thereby reducing the need to adjust a focus and a position of the image camera. The presenter can thus devote more attention to the content of the document.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a schematic diagram of a conventional document camera in the process of capturing a document for presentation;

FIG. 2 is a schematic diagram of a document camera combined with a document positioning apparatus in accordance with an embodiment of the present invention;

FIG. 3 is a bottom view of a document positioning apparatus in accordance with an embodiment of the present invention; and

FIG. 4 is a side view of a document positioning apparatus in accordance with an embodiment of the present invention.

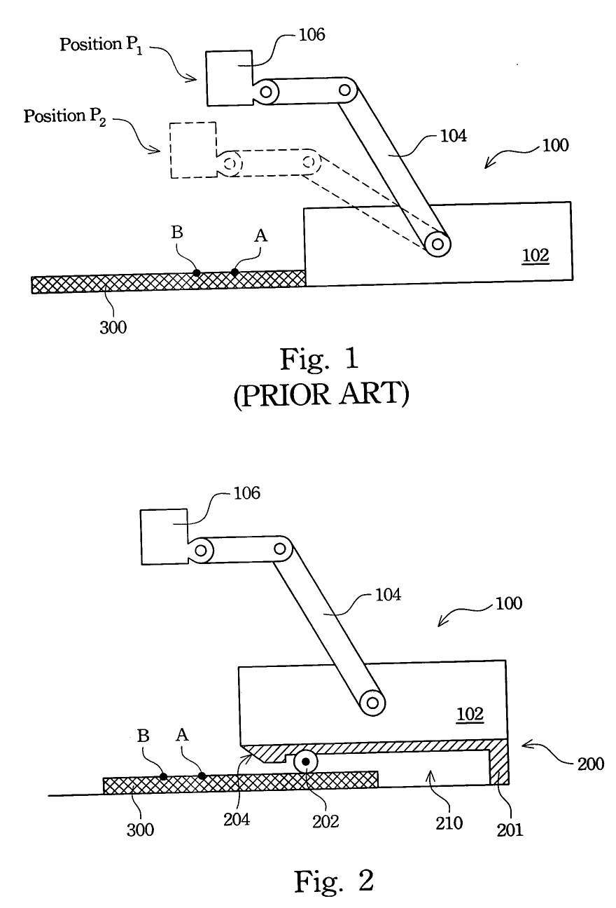

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the prior art described above, when a document camera is used to capture a document for presentation, it is necessary for a presenter to move the image camera to a suitable capture position because of the physical limitation of a base of the document camera. In order to resolve the problem, the present invention provides a document positioning apparatus combined with a document camera, so that a document is easily moved to a position under the image camera. The need adjust a focus and a position of the image camera is thereby reduced.

Reference is made to FIG. 2, which is a schematic diagram of a document camera combined with a document positioning apparatus in accordance with an embodiment of the present invention. In this embodiment, when the document positioning apparatus 200 is used, the document positioning apparatus 200 is disposed under the base 102 of the document camera 100. A roller 202 is installed on a bottom surface 210 of the supporter 201, which is one part of the document positioning apparatus 200, so as to move a document 300 to a desired position. A presenter manually moves the document 300 into a gap between the bottom surface 210 and a ground surface. The supporter 201 is disposed on the ground surface. A document guider 204 is formed on an edge of the supporter 201 to smooth document 300, and guide the document 300 into the gap under the supporter 201 easily. By using the document positioning apparatus 200, when the image camera 106 of the document camera 100 is in a fixed position, the image camera 106 can capture a surrounding image centered at A or B by moving the document 300.

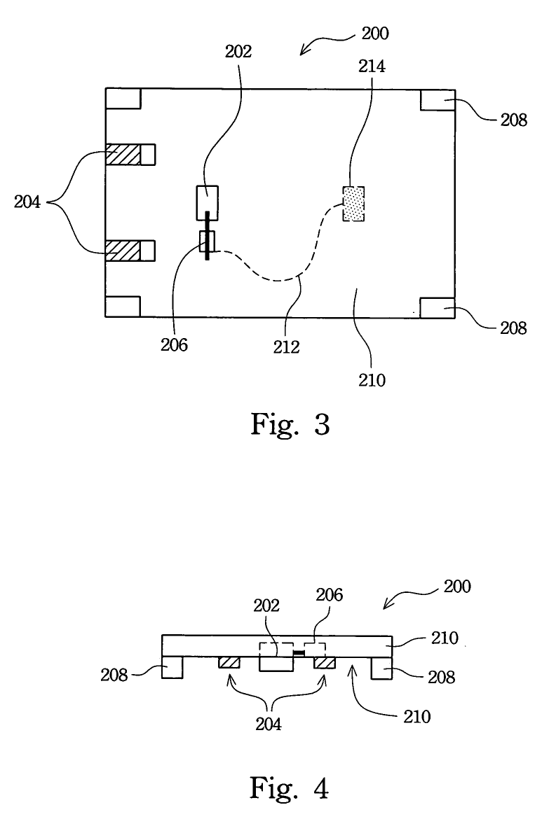

FIG. 3 and FIG. 4 are a bottom view and a side view of a document positioning apparatus in accordance with an embodiment of the present invention, respectively. The supporter 201 of the document positioning apparatus 200 comprises four pedestals 208 for forming a gap between a bottom surface 210 of the supporter 201 and a ground surface. The roller 202 installed on the bottom surface 210 is connected to and driven by a motor 206. The motor 206 is electrically connected to a connector 214 through a wire 212. The dashed line 212 in FIG. 3 indicates the wire 212 that cannot be seen from the bottom view. The document positioning apparatus 200 is electrically connected to the base 102 of the document camera 100 through the connector 214. The power and the control signal are thereby obtained by the motor 206. In one embodiment, an independent power (not shown) connected to the motor 206 is installed in the supporter 201 so as to supply an operation power to the motor 206. The roller 202 is installed on the bottom surface 210 in any suitable position, if necessary. In this embodiment, the document guider 204 is designed to have two divided parts. However, the document guider 204 can be designed to have only one part or numerous parts.

As described in above preferred embodiment of the present invention, by using the document positioning apparatus combined with the document camera, the guided document is moved to a position under the image camera through the roller, thereby reducing an adjustment of a focus and a position of the image camera. Accordingly, the presenter can devote more attention to the content of the document.

Referring to FIG. 2 again, as described above, when the document positioning apparatus 200 is used, the document positioning apparatus 200 is disposed under the base 102 of the document camera 100. It has been noted, however, that the document positioning apparatus 200 without the roller 202 and/or the document guider 204 is also available, that is, any arrangement permitting the guided document 300 to be shifted into the gap under the document positioning apparatus 200 is allowable.

In addition, according to the operation of the conventional document camera 100, if a surrounding light is insufficient, the presenter may use a light set (not shown) to enhance the intensity of the light, thereby improving the effect of projection. In general, the light set includes two tubes, two arms and a base. The detailed structure of the light set includes two ends of the base connected to a separate arm and the arms are connected to a separate tube. When the light set is used, the two tubes are disposed in front of and above the two sides of the base and the light of the tubes are emitted toward a direction of a document thereby to provide a light intensity enough for capturing the document. Therefore, according to the document positioning apparatus 200 of the present invention, the base of the light set could be combined with the base 102, that is, the document positioning apparatus 200 is disposed under the base of the light set and the base 102, so that the document 300 could be shifted into a gap of the document positioning apparatus 200 under the base of the light set and the base 102 and thereby to reduce an adjustment of a focus and a position of the image camera.

As disclosed above, according to the document positioning apparatus combined with a document camera of the present invention, a presenter can move a document to a position under the image camera easily and devote more attention to the content of the document, regardless of the physical limitations of a base of the document camera. The need to adjust a focus and a position of the image camera is thereby reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A document positioning apparatus, comprising:
a supporter, wherein said supporter is disposed under a base of a document camera, a gap is formed between said supporter and a ground surface used to support said supporter, and the gap is designed to be large enough for a document to shift;
a roller device, wherein said roller is installed on a bottom surface of said supporter for moving the document to achieve a desired position; and
a document guider, wherein said document guider is formed on an edge of said supporter for guiding the document into the gap under said supporter easily.

2. The document positioning apparatus of claim 1, wherein said roller device is connected to and driven by a motor.

3. The document positioning apparatus of claim 2, further comprising a connector connected to said supporter and said document camera so as to obtain a power.

4. The document positioning apparatus of claim 3, wherein said connector is electrically connected to said motor so as to provide the power to said motor for driving said roller device.

5. A document positioning apparatus, comprising:
a supporter, wherein said supporter is disposed under a base of a document camera, a gap is formed between said supporter and a ground surface used to support said supporter, and the gap is designed to be large enough for a document to shift.

6. The document positioning apparatus of claim 5, further comprising a document guider, wherein said document guider is formed on an edge of said supporter for guiding the document into the gap under said supporter easily.

7. The document positioning apparatus of claim 5, wherein a base of a light set is combined with said document positioning apparatus, wherein the document is shifted into the gap of said document positioning apparatus under the base of the light set and the base of said document camera.
